(19) United States
(12) Patent Application Publication
(10) Pub. No.: US 2004/0119918 A1
(43) Pub. Date: Jun. 24, 2004

(54) Electro-optic device, manufacturing method thereof, and electronic apparatus

(76) Inventor: Kazuyoshi Sakai, Nagano-ken (JP)

Correspondence Address: HARNESS, DICKEY & PIERCE, P.L.C., P.O. BOX 828, BLOOMFIELD HILLS, MI, 48303, US

(21) Appl. No.: 10/692,300

(22) Filed: Oct. 23, 2003

(30) Foreign Application Priority Data
Oct. 25, 2002 (JP) 2002-311054

(51) Int. Cl. G02F 1/1335

(52) U.S. Cl. 349/113

(57) ABSTRACT

On a substrate of a rear board of a liquid crystal display device, reflection electrodes are provided which are composed of an underlying insulating layer, reflective conductive layers made of Ag alone or an Ag alloy, and transparent conductive layers made of a transparent conductive material such as ITO provided in that order from the bottom. The transparent conductive layer is formed larger in thickness than that of the reflective conductive layer. The reflective conductive layer preferably has a thickness in the range of 80 nm to 300 nm.

### BACKGROUND OF THE INVENTION

1. Technical Field

The present invention relates to electro-optic devices, manufacturing methods thereof, and electronic apparatuses, and more particularly, relates to the structure of an electro-optic device suitably used as a display device provided with light-reflection layers.

2. Related Art

In general, liquid crystal display devices, which are one type of an electro-optic device, have been widely used as display means used for various electronic apparatuses. The liquid crystal display devices each have a basic cell structure formed of a pair of substrates and liquid crystal enclosed between the substrates. As these sorts of liquid crystal display devices, a reflective liquid crystal display device using external light as display light has been commonly used, for example, for mobile electronic apparatuses. In addition, in recent years, a transflective liquid crystal display device has also been introduced on the market, which can perform transmissive display using light emitted from a backlight in dark places and reflective display using external light in bright places.

In the reflective liquid crystal display device or the transflective liquid crystal display device described above, a reflection layer is generally provided at the rear side (side opposite to an observer) of the liquid crystal in the basic cell structure described above. As the reflection layer, a thin metal film made of aluminum or the like is used in many cases. In the transflective liquid crystal display device, open portions (window portions) for respective pixels are provided in a reflection layer, and when light emitted from a backlight passes through those open portions, transmissive display can be performed. This reflection layer may also be formed to serve as a reflection electrode for applying an electric field to the liquid crystal in some cases, or by providing a transparent electrode or the like in addition to the reflection layer, the reflection layer may only have a light reflection function in some cases.

In recent years, even for relatively small liquid display crystal devices used for cell phones and the like, there has been an increasing trend toward color display and highly fine display quality, and hence brighter reflective display has been required for both reflective and transflective liquid crystal display devices. Accordingly, recently, as a material for a thin metal film forming a reflection layer, the use of a silver (Ag) alloy such as an Ag—Pd—Cu (APC) alloy has started which has a high light reflectance as compared to that of aluminum. Since Ag alloy also has low electrical resistance, this Ag alloy is also used as a material for forming electrodes or wirings. However, since an APC alloy generally has poor water resistance, when a patterned thin film made of an APC alloy is brought into contact with hot water in a manufacturing process, the metal thereof may be disadvantageously ionized and dissolved, and/or when a voltage is applied to the APC alloy, electromigration and/or electrical corrosion thereof may also disadvantageously occur in some cases.

In addition, since an Ag alloy has generally poor adhesion to a glass substrate, it is difficult to provide an Ag alloy directly on the substrate. As described above, when only an APC alloy is used, various problems occur; hence, in order to solve the problems, a method has been proposed in which an indium tin oxide (ITO) film is provided on or under a reflection layer to form a laminate.

In the conventional liquid crystal display device described above, when only an alignment film is provided between an Ag alloy and liquid crystal, since a transparent electrode opposing the Ag alloy is formed of a material different therefrom, for example, a known problem may arise in that polarization occurs therebetween and/or the Ag alloy is dissolved in liquid crystal. Hence, a method for forming a laminate has been proposed which is composed of an Ag alloy film and a thin film of a conductive metal oxide such as ITO provided thereon.

However, even when a transparent conductive layer is formed on an Ag alloy film, in the case in which the transparent conductive layer does not have enough thickness, by heating or the like performed in a subsequent manufacturing step, migration or the like occurs on the surface of the Ag alloy film, and as a result, the surface thereof is disadvantageously damaged, thereby decreasing the reflectance of the Ag alloy. In addition, in order to ensure sufficient corrosion resistance of an Ag alloy film, the Ag alloy film must be reliably covered with a transparent conductive layer, and hence precise control of a manufacturing process must be conducted. In particular, when a laminate structure composed of an Ag alloy film and a transparent conductive layer is used for an external wiring, there has been a problem in that electrical corrosion or another type of corrosion of the external wiring cannot be completely avoided.

Accordingly, the present invention was made to solve the problems described above, and an object of the present invention is to provide the structure of an electro-optic device using reflective conductive layers made of Ag alone or an Ag alloy, in which a decrease in reflectance of the reflective conductive layers and/or corrosion thereof can be completely avoided.

### SUMMARY

In order to achieve the object of the present invention, an electro-optic device in accordance with one aspect of the present invention, which has a pair of substrates, an electro-optic material disposed between the substrates, and means for applying an electric field to the electro-optic material, comprises: a material enclosure region in which the electro-optic material is enclosed; reflection electrodes provided on one of the pair of substrates in the material enclosure region, having a multilayer structure composed of a reflective conductive layer made of Ag alone or an Ag alloy and a transparent conductive layer made of a transparent conductive material provided thereon; and external wirings connected to the reflection electrodes and provided outside the material enclosure region, having a transparent conductive layer and no reflective conductive layer, which are equivalent to those of the multilayer structure. In the electro-optic device described above, the transparent conductive layer of the reflection electrodes has a thickness larger than that of the corresponding reflective conductive layer.

According to the present invention, since the reflection electrode has a multilayer structure composed of the reflective conductive layer and the transparent conductive layer provided thereon, and in this multilayer structure, the transparent conductive layer provided on the reflective conductive layer has a thickness larger than that thereof, the coverage of the reflective conductive layer by the transparent conductive layer can be increased. Hence, a decrease in reflectance caused, for example, by migration of the reflective conductive layer can be suppressed, and in addition, the wiring resistance of the external wirings can be decreased, each of which comprises the transparent conductive layer and includes no reflective conductive layer.

In the present invention, the reflective conductive layer is formed of Ag alone or an Ag alloy, and in both cases mentioned above, high reflectance and low electrical resistance can both be satisfied. In addition, by forming the thick transparent conductive layers on the respective reflective conductive layers, since the generation of migration or the like of Ag alone or an Ag alloy can be suppressed, the smoothness of the reflection surface can be maintained so as to suppress the decrease in reflectance, and in addition, the electrical reliability can be further improved.

In addition, the reflection electrodes are provided inside the material enclosure region of the electro-optic device, each of which is composed of the reflective conductive layer and the transparent conductive layer formed thereon, and outside the material exposure region, the external wirings are formed, each of which comprises the transparent conductive layer and includes no reflective conductive layer. Hence, corrosion such as electrical corrosion of the Ag alone or the Ag alloy forming the reflective conductive layer can be prevented.

Inside the material enclosure region, as is the reflection electrode described above, internal wirings are preferably formed each having a multilayer structure formed of a reflective conductive layer and a transparent conductive layer provided thereon. According to the structure described above, the wiring resistance in the material enclosure region can be decreased.

In the present invention, the reflective conductive layer preferably has a thickness of 80 nm to 300 nm. When the thickness of the transparent conductive layer is 80 nm or more, irregularities of the surface of the reflective conductive layer, which are caused by migration or the like, are unlikely to be formed, and hence a decrease in reflectance can be suppressed. In addition, when the thickness of the reflective conductive layer is 300 nm or less, a decrease in reflectance caused by the growth of large grains or the like can be suppressed.

In the present invention, the electro-optic device may further comprise an underlying insulating layer between one of the pair of substrates and the reflective conductive layers in order to improve the adhesion thereof. Accordingly, by forming the reflective conductive layers on the underlying insulating layer, the adhesion of the reflective conductive layers can be improved, and in addition, the probability of electrical corrosion generated between the reflection electrodes and/or between the internal wirings can be decreased as compared to the case in which a conductive layer made of ITO or the like is used as an underlying layer.

Next, in accordance with another aspect of the present invention, there is provided a method for manufacturing an electro-optic device having a pair of substrates, an electro-optic material provided between the substrates, and means for applying an electric field to the electro-optic material. The method described above comprises: a step of forming reflective conductive layers made of Ag alone or an Ag alloy on one of the pair of substrates selectively only in a first region to be used as a material enclosure region in which the electro-optic material is enclosed; and a step of forming transparent conductive layers made of a transparent conductive material in the first region and a second region located outside the material enclosure region, the transparent conductive layers having a thickness larger than that of the reflective conductive layers.

According to the present invention, by forming the thick transparent conductive layers on the reflective conductive layers, the decrease in reflectance and/or the decrease in electrical reliability, which is caused by migration or the like of the reflection conductive layer, can be suppressed. In addition, since the thickness of the transparent conductive layer is formed larger than that of the reflective conductive layer, the electrical resistance of the external wirings formed outside the material enclosure region can be decreased.

In the present invention, the reflective conductive layer preferably has a thickness of 80 nm to 300 nm. When the thickness of the transparent conductive layer is 80 nm or more, since irregularities caused by migration is unlikely to be generated on the surface of the reflective conductive layer, a decrease in reflectance can be suppressed. In addition, when the reflective conductive layer has a thickness of 300 nm or less, a decrease in reflectance resulting from the growth of larger grains or the like can be suppressed.

In the present invention, the method for manufacturing an electro-optic device may further comprise a step of forming an underlying insulating layer between one of the pair of substrates and the reflective conductive layers for enhancing the adhesion thereof. Accordingly, by forming the reflective conductive layers on the underlying insulating layer, the adhesion of the reflective conductive layers can be improved, and in addition, compared to the case in which conductive layers made of ITO are used as an underlying layer, the probability of electrical corrosion between the reflection electrodes and/or between the internal wirings can be decreased.

Next, in accordance with still another aspect of the present invention, there is provided an electronic apparatus which comprises one of the electro-optic devices described above and control means for controlling the electro-optic device. Since it is formed as a reflective electro-optic device or a transflective liquid crystal display device, the electro-optic device described above is preferably used for mobile electronic apparatuses which are used outdoors in many cases and which have a limitation of electric power capacity.

### BRIEF DESCRIPTION OF THE DRAWINGS

FIG. 1 is a schematic perspective view showing the entire structure of a liquid crystal display device which is an embodiment of an electro-optic device according to the present invention.

FIG. 2 is a schematic cross-sectional view of the structure of the liquid crystal display device which is an embodiment of an electro-optic device according to the present invention.

FIG. 3 is a plan view of the structure of the liquid crystal display device which is an embodiment of an electro-optic device according to the present invention.

FIGS. 4(a), 4(b), and 4(c) are schematic partial cross-sectional views each showing the structure on a substrate of a rear board of the liquid crystal display device which is an embodiment of an electro-optic device according to the present invention.

FIGS. 5(a) to 5(d) are cross-sectional views each showing a step of manufacturing the structure on the substrate of the rear board of the liquid crystal display device which is an embodiment of an electro-optic device according to the present invention.

FIG. 6 is a graph showing the relationship between the reflectance and the thickness of a reflective conductive layer provided at the rear board of the liquid crystal display device which is an embodiment of an electro-optic device according to the present invention.

FIG. 7 is a graph showing the relationship between the thickness of a transparent conductive layer and the thickness of a reflective conductive layer.

FIG. 8 is a block diagram showing the structure of a display control system of an electronic apparatus provided with a liquid crystal display device.

FIG. 9 is a schematic perspective view showing the appearance of a mobile phone as an example of an electronic apparatus.

### DETAILED DESCRIPTION

Next, embodiments of an electro-optic device, a manufacturing method thereof, and an electronic apparatus of the present invention will be described with reference to accompanying drawings.

Structure of Liquid Crystal Display Device

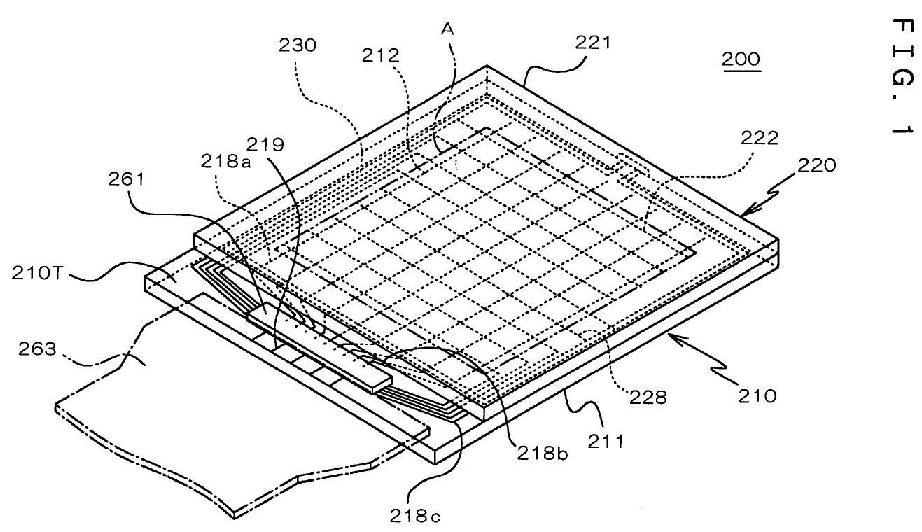

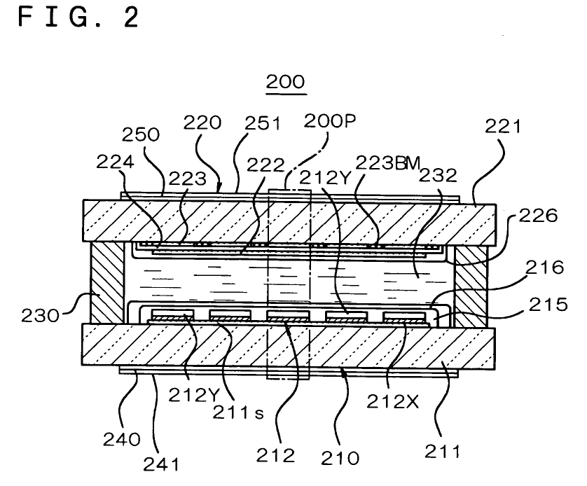

First, the structure of a liquid crystal display device 200 will be described with reference to FIGS. 1 to 3. FIG. 1 is a schematic perspective view of the liquid crystal display device 200 as the electro-optic device according to this embodiment, FIG. 2 is a schematic cross-sectional view of the structure of the liquid crystal display device 200, and FIG. 3 is a schematic plan view of the liquid crystal display device 200.

The liquid crystal display device 200 has a basic cell structure in which a rear board 210 and a front board 220 are bonded to each other with a sealing material 230, and liquid crystal 232, that is, an electro-optic material, is filled inside this sealing material 230. In the liquid crystal display device 200, the rear board 210 has a substrate 211 composed, for example, of plastic or glass such as non-alkali glass and constituent elements, such as electrodes and wirings, formed on the internal surface of the substrate 211, and the front board 220 has a substrate 221 similar to the substrate 211 and constituent elements, such as electrodes and wirings, formed on the internal surface of the substrate 221.

On the substrate 211, reflection electrodes 212 having a multilayer structure, which will be described later, are provided in a display region A shown in FIG. 1, and in addition, internal wirings 218a integrally formed with the reflection electrodes 212 for electrical connection are also provided in a liquid crystal enclosure region surrounded by the sealing material 230. The reflection electrodes 212 and the internal wirings 218a each have a strip shape and are arranged in a stripe pattern.

In addition, the rear board 210 including the substrate 211 has a protruding portion 210T extending outside from the front board 220 including the substrate 221. On this protruding portion 210T, external wirings 218b are formed for electrical connection with the internal wirings 218a. In addition, on the protruding portion 210T, external wirings 218c are also formed extending from the sealing material 230.

In addition, on the substrate 221, transparent electrodes 222 composed of a transparent conductive material such as indium tin oxide (ITO) are formed in the display region A shown in FIG. 1. The transparent electrodes 222 each have a strip shape and are arranged to have a stripe pattern. The transparent electrodes 222 are extended outside from the display region A for electrical connection with internal wirings 228. The internal wirings 228 are electrically connected with the external wirings 218c via vertical conductors 230x (see FIG. 3) formed, for example, in parts of the sealing material 230.

On the protruding portion 210T, a semiconductor IC chip 261 is mounted. The external wirings 218b and 218c extended to the protruding portion 210T are electrically connected to chip terminals (not shown in the figure) of the semiconductor IC chip 261. In this semiconductor IC chip 261, for example, a liquid crystal drive circuit is formed. The semiconductor IC chip 261 is also electrically connected to input terminals 219 provided on the protruding portion 210T. On the input terminals 219, a flexible circuit board 263 indicated by an alternate long and short dash line shown in FIG. 1 is provided.

When a liquid crystal display device capable of performing color display is formed, on the internal surface of the substrate 221, as shown in FIG. 2, color filters having color layers 223 covered with a protection film 224 are formed. The color layer 223 is formed of a transparent organic resin and a pigment or a dye added thereto. In addition, between pixels 200P described later (see FIG. 2), a shading layer 223BM formed of a black resin or the like is provided whenever necessary. Furthermore, the protection film 224 is formed of a transparent material such as an acrylic resin. On the color filters, the transparent electrodes 222 are formed.

On the surfaces of the rear board 210 and the front board 220, alignment films 216 and 226 made of a polyimide resin or the like are formed, respectively. The alignment films 216 and 226 are each processed by alignment treatment, for example, rubbing treatment so as to have the ability of determining the initial orientation state of the liquid crystal 232. In addition, as shown in FIG. 3, the reflection electrodes 212 and the transparent electrodes 222 orthogonally intersect each other in plan view, and regions at which the two types of electrodes overlap each other in plan view form pixels 200P shown in FIG. 2.

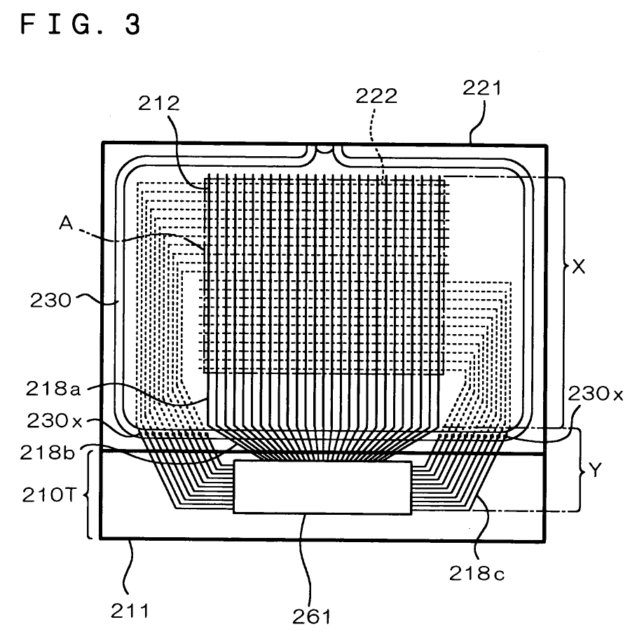

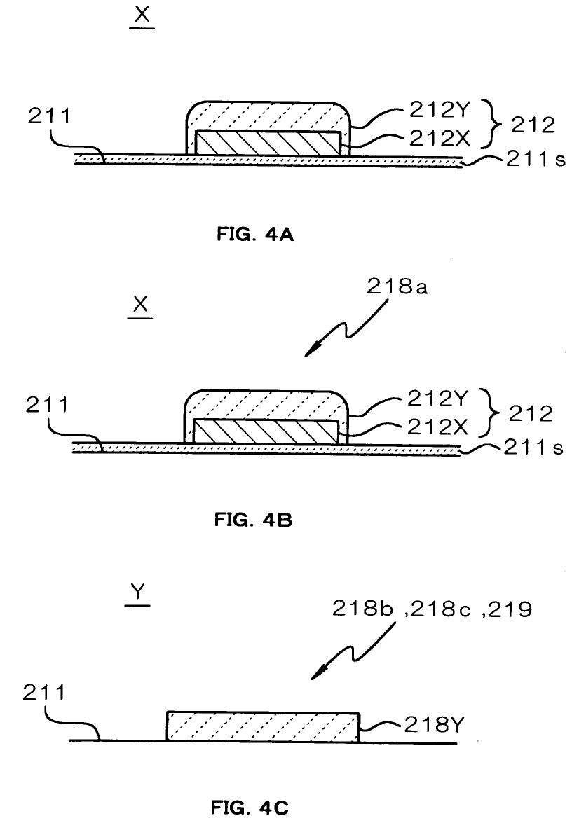

Next, the structure of the liquid crystal display device 200 will be described in more detail. On the internal surface of the substrate 211, as shown in FIG. 4(a), an underlying insulating layer 211s is provided which is formed from a transparent inorganic insulating layer of a metal oxide such as TiO₂ or a transparent organic insulating material such as an acrylic resin. On this underlying insulating layer 211s, reflection electrodes 212 are provided. The reflection electrodes 212 are each formed of a reflective conductive layer 212X made of Ag alone or an Ag alloy and a transparent conductive layer 212Y provided thereon, which is composed of a transparent conductive material such as ITO.

This underlying insulating layer 211s is provided for improving the adhesion between the reflective conductive layer 212X and the substrate 211. When the underlying insulating layer 211s has a thickness of approximately 5 nm, the adhesion of the reflective conductive layer 212X can be sufficiently improved; hence, the thickness thereof is preferably in the range of approximately 5 nm to 100 nm, and in particular, in order to decrease steps in the cell, the thickness is more preferably in the range of approximately 5 nm to 10 nm.

In addition, the reflective conductive layer 212X may be formed of Ag alone or various alloys primarily composed of Ag. In particular, the above-mentioned APC alloy is preferably used, and for example, preferably used as the alloys are an alloy containing approximately 98 percent by weight of Ag, and adding platinum (Pt) and copper (Cu); an alloy containing Ag in the same amount as that described above, and adding Cu and gold (Au); and an alloy containing Ag in the same amount as that described above, and adding ruthenium (Ru) and Cu. The thickness of this reflective conductive layer 212X is preferably in the range of approximately 80 nm to 300 nm and more preferably approximately 150 nm.

The transparent conductive layer 212Y is formed to cover the entire surface of the reflective conductive layer 212X. In this embodiment shown in the figure, the underlying insulating layer 211s is formed over approximately the entire display region A, the reflective conductive layers 212X are formed on the underlying insulating layer 211s, and in addition, the transparent conductive layers 212Y each having an area (width) slightly larger than that of the reflective conductive layer 212X are formed so as to cover the entirety thereof. However, unlike the structure shown in the figure, the underlying insulating layer 211s may be patterned into pieces independent of each other for the respective reflection electrodes 212. As the transparent conductive layer 212Y, any material may be used which has transparent properties to some extent and sufficient conductivity used as an electrode for an electro-optic material (liquid crystal), and in general, a conductive metal oxide having light-transmitting properties is used. In particular, ITO is preferably used.

The thickness of the transparent conductive layer 212Y is formed larger than that of the reflective conductive layer. In this embodiment, the thickness of the transparent conductive layer 212Y is preferably in the range of approximately 120 nm to 350 nm. When the thickness of the transparent conductive layer 212Y is smaller than that of the reflective conductive layer 212X, it becomes difficult to entirely cover the reflective conductive layer 212X with the transparent conductive layer 212Y, and corrosion resistance of the reflective conductive layer 212X is deteriorated, so that corrosion such as electrical corrosion is likely to occur. In addition, migration caused, for example, by thermal history in a manufacturing process is liable to occur, and the surface of the reflective conductive layer 212X is damaged, resulting in a decrease in reflectance.

On the other hand, when the thickness of the transparent conductive layer 212Y is more than 350 nm, in addition to an increase in the internal stress thereof, thermal stress applied to the reflective conductive layer 212X from the transparent conductive layer 212Y, which is caused by the differences in thermal expansions, is increased, and hence a stress is likely to be concentrated on the edge portions of the reflective conductive layer. As a result, structural defects such as hillocks are likely to occur, and in particular, the electrical reliability may be decreased. Furthermore, by the increased step in the cell, the display performance of liquid crystal display device is deteriorated.

In addition, as shown in FIG. 4(b), the internal wiring 218a provided inside the sealing material 230 is formed to have a multilayer structure exactly equivalent to that of the reflection electrode 212. That is, on the underlying insulating layer 211s which is the same as that described above, a multilayer structure is provided which is composed of a reflective conductive layer 218X formed of Ag alone or an Ag alloy and a transparent conductive layer 218Y formed of a transparent conductive material such as ITO. The reflective conductive layer 218X is formed integrally with the reflective conductive layer 212X of the reflection electrode 212 at the same time by using the same material as that for the reflective conductive layer 212X so as to have the same thickness as that thereof. In addition, the transparent conductive layer 218Y is formed integrally with the transparent conductive layer 212Y of the reflection electrode 212 at the same time by using the same material as that for the transparent conductive layer 212Y so as to have the same thickness as that thereof.

On the reflection electrodes 212 and the internal wirings 218a, a protection film 215 is provided as shown in FIG. 2, which is made from a transparent insulating layer composed, for example, of an inorganic material, such as TiO₂ or SiO₂, or a transparent organic resin such as an acrylic resin. This protection film 215 serves to protect the reflection electrodes 212 and also functions to prevent electrical short-circuiting between the reflection electrodes 212 and the transparent electrodes 222 caused by foreign materials which enter between the rear board 210 and the front board 220.

The reflection electrodes 212 and the internal wirings 218a on the substrate 211 shown in FIGS. 4(a) and 4(b) are formed over the region X shown in FIG. 3. That is, the three-layered structures each composed of the underlying insulating layer, reflective conductive layer, and the transparent conductive layer are definitely formed inside the sealing material 230, i.e., in the liquid crystal enclosure region. In other words, the reflective conductive layers 212X and 218X are definitely formed in the liquid crystal enclosure region.

On the other hand, outside the liquid crystal enclosure region, the external wirings 218b and 218c and the input terminals 219 are formed, and as shown in FIG. 4(c), they are only formed of the transparent conductive layers 218Y as described above. That is, the external wirings 218b and 218c and the input terminals 219 disposed outside the liquid crystal enclosure region are not provided with the reflective conductive layers 218X forming the internal wirings 218a. The liquid crystal enclosure region is generally sealed with the sealing material 230; however, compared to the liquid crystal enclosure region, the region outside thereof is liable to be contaminated by foreign materials although the protruding portion 210T located outside the liquid crystal enclosure region may be finally covered with a silicone molding compound or the like in some cases. However, since the external wirings 218b and 218c and the input terminals 219 are not provided with the reflective conductive layers 218X, corrosion such as electrical corrosion of the reflective conductive layer 218X can be prevented. In addition, in this embodiment, since the transparent conductive layers 212Y and 218Y provided on the reflective conductive layers 212X and 218X, respectively, are formed thick as described above, the external wirings 218b and 218c and the input terminals 219 are also formed thick, and as a result, the resistance of the wirings and the terminals can be decreased.

Manufacturing Method of Liquid Crystal Display Device

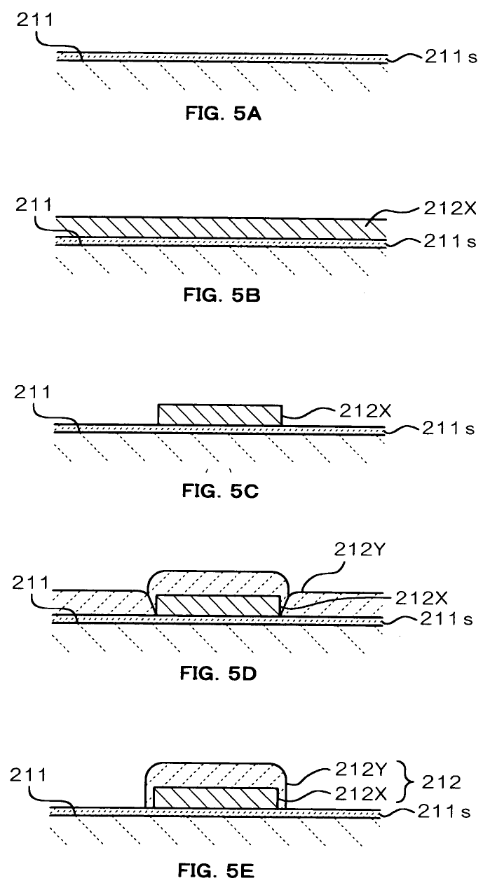

Next, as one embodiment of a manufacturing method of an electro-optic device of the present invention, a method for manufacturing the liquid crystal display device 200 will be described. First, referring to FIG. 5, in a process for manufacturing the rear board 210, steps of manufacturing the reflection electrodes 212, the internal wirings 218a, the external wirings 218b and 218c, and the input terminals 219 on the substrate 211 will be described. In this embodiment, a region in which the reflection electrode 212 is formed is only shown in FIG. 5.

As shown in FIG. 5(a), on the surface of the substrate 211, the underlying insulating layer 211s composed of an insulating material is first formed by sputtering or the like. The thickness of the underlying insulating layer 211s is, for example, 5 nm as described above.

Next, as shown in FIG. 5(b), on the underlying insulating layer 211s, Ag alone or an Ag alloy is deposited by sputtering or deposition to form a reflective conductive layer 212X (218x). The thickness of this reflective conductive layer 212X (218x) is, for example, 150 nm. Subsequently, by patterning, the reflective conductive layer 212X (218x) is selectively formed into portions at which the reflection electrodes 212 and the internal wirings 218a are formed. That is, in the region X shown in FIG. 3, unnecessary parts of the reflective conductive layer 212X (218x) above the substrate 211 are all removed so as to form stripe patterns which form the reflection electrodes 212 and the internal wirings 218a. Accordingly, parts of the reflective conductive layer remain only inside a first region on the substrate 211 which corresponds to the liquid crystal enclosure region.

For forming the reflective conductive layers 212X (218X), patterning may be performed, for example, by a known photolithography method using photoresist. That is, after a mask is formed by pattering photoresist using exposure and development techniques, the reflective conductive layer 212X (218x) is etched using this mask. As an etchant used for this etching, a material having a high etching rate for the reflective conductive layer and a low etching rate for the underlying insulating layer, that is, a material having a high selectivity, is used. As the etchant described above, for example, there may be mentioned a mixed acid etchant containing phosphoric acid and/or its derivative.

Next, on the reflective conductive layers 212X (218x) thus formed by patterning and the underlying insulating layer 211s or the substrate 211, which is exposed between the reflective conductive layers 212X (218x), a transparent conductive layer 212Y (218Y) is formed from ITO as shown in FIG. 5(d). This transparent conductive layer 212Y (218Y) is formed by sputtering and is then preferably annealed at a predetermined temperature. The annealing may be performed at a temperature of 180 to 280° C.

However, since the transparent conductive layer 212Y (218Y) is provided on the reflective conductive layers 212X (218X), in order to prevent the migration thereof, the annealing temperature is preferably equivalent to or less than a melting temperature of the reflective conductive layers and is set, for example, to 180 to 230° C.

The transparent conductive layer 212Y (218Y) is formed so that the thickness thereof is larger than that of the reflective conductive layer 212X (218X) and is set, for example, to 200 nm. In this embodiment, in regions in which the reflective conductive layers are not provided, that is, in regions which are in the first region corresponding to the liquid crystal enclosure region, the transparent conductive layer 212Y (218Y) is formed on the underlying insulating layer 211s; in which the reflective conductive layers are not provided, and in a second region outside the first region, the transparent conductive layer 212Y (218Y) is directly formed on the substrate 211.

Subsequently, the transparent conductive layer 212Y (218Y) is patterned to form the reflection electrodes 212, the internal wirings 218a, the external wirings 218b and 218c, and the input terminals 219. In this patterning step, unnecessary parts are simultaneously removed using a predetermined mask. That is, parts other than the reflection electrodes 212, the internal wirings 218a, the external wirings 218b and 218c, and the input terminals 219 on the substrate 211 are removed at the same time. As an etchant for this etching, a strong acid such as aqua regia may be used.

Characteristics of Multilayer Structure

Next, the three-layered structure of the reflection electrode 212 and the internal wiring 218a will be described in detail. In this three-layered structure, by the reflective conductive layers 212X and 218X, and the transparent conductive layers 212Y and 218Y, the volume resistivity required for the electrode and the internal wiring can be realized, and by covering the reflective conductive layers 212X and 218X with the transparent conductive layers 212Y and 218Y, respectively, migration of Ag alone or an Ag alloy and mechanical (physical) damage done thereto can be suppressed.

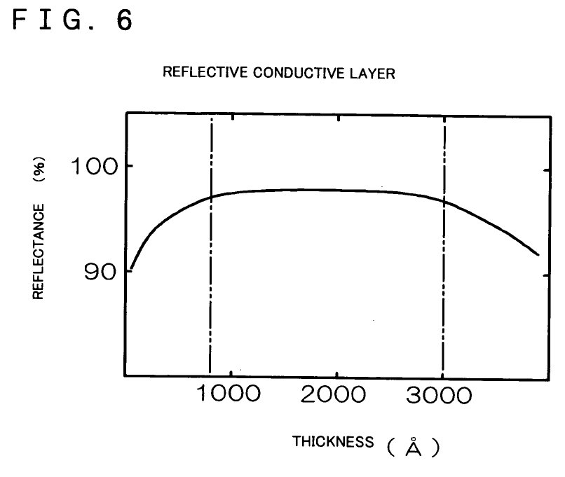

As shown in FIG. 6, the reflectance of the reflective conductive layers 212X and 218X varies in accordance with the change in thickness thereof. For example, when the thickness is less than 80 nm, the transparency is increased, and in accordance with this increase, the reflectance is decreased. In addition, when the thickness is more than 300 nm, since grains in the layer grow larger so that the irregularities of the surface are enhanced, the reflectance which contributes to display performance is decreased. Furthermore, since the thickness of the multilayer structure including the transparent conductive layer is increased, the steps in the cell in the display region A are increased, and as a result, the display performance of liquid crystal is deteriorated. Accordingly, the thickness of the reflective conductive layer is preferably in the range of 80 nm to 300 nm.

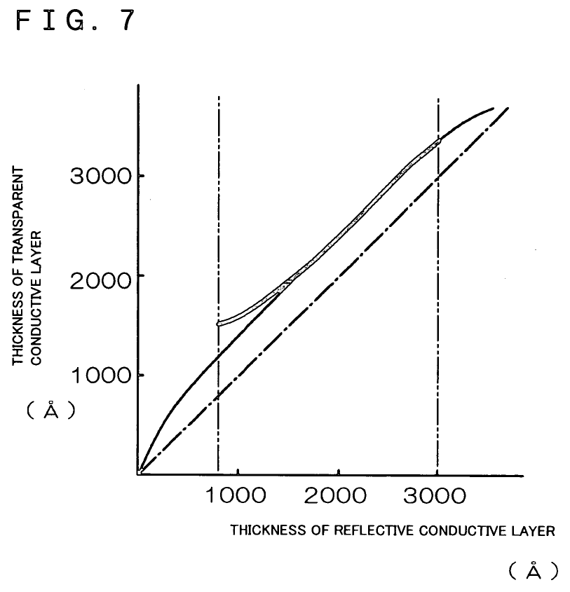

In addition, the topmost transparent conductive layer 212Y (218Y) is formed to have a large thickness as compared to that of the reflective conductive layer 212X (218X). The reasons for this are that when the transparent conductive layers 212Y (218Y), which has a larger thickness, is formed on the reflective conductive layer 212X (218X), since the coverage thereof is improved and migration of the reflective conductive layer 212X (218X) can be suppressed, a decrease in reflectance is prevented, and in addition, the wire resistance of the external wirings 218b and 218c and the terminal resistance of the input terminal 219 can also be decreased. The thickness of this transparent conductive layer is preferably set, for example, in the range of approximately 120 nm to 350 nm. In FIG. 7, the thickness of the transparent conductive layer is shown which can cover the entire reflective conductive layer including the side surfaces thereof. As shown by a thin line shown in the figure, when the thickness of the transparent conductive layer is formed slightly larger than that of the reflective conductive layer, the reflective conductive layer can be entirely covered. For example, when the reflective conductive layer has a thickness in the range of 80 nm to 300 nm, a transparent conductive layer having a thickness larger than that of the reflective conductive layer by approximately 30 nm to 50 nm can substantially cover the entirety thereof, and as a result, the corrosion resistance of the reflective conductive layer can be enhanced.

In this embodiment, when the thickness of the reflective conductive layer is set to more than 300 nm, such as 350 nm to 400 nm, the reflectance is decreased by increasing the amount of scattered light, and in addition, by the increased step in the cell in the display region A, the display quality is deteriorated. In addition, when the thickness of the reflective conductive layer is set to less than 80 nm, such as 40 nm to 60 nm, the reflectance itself of the reflective conductive layer is decreased. Furthermore, when the thickness of the transparent conductive layer is further decreased so that, for example, the thickness thereof is approximately 100 nm with respect to a thickness of the reflective conductive layer of 150 nm, since the surface conditions of the reflective conductive layer are deteriorated, the reflectance thereof is decreased, and in addition, the wire resistance of the external wiring is increased, resulting in degradation in display quality.

In this embodiment, since the thick transparent conductive layers 212Y and 218Y are simply formed on the reflective conductive layers 212X and 218X, respectively, as described above, in order to sufficiently decrease the electrical resistance of the electrode and the wiring, the reflective conductive layer and the transparent conductive layer must be formed to have a total thickness of at least approximately 250 nm. Accordingly, when the thickness of the reflective conductive layer is in the range of 80 nm to 300 nm, as indicated by a thick line shown in FIG. 7, the transparent conductive layer is preferably formed to have a thickness larger than that of the reflective conductive layer by more than approximately 50 nm to 100 nm in the region in which the reflective conductive layer has a small thickness.

In this embodiment, since the reflective conductive layers 212X and 218X are formed on the underlying insulating layer 211s, compared to the case in which a conductive layer made of ITO or the like is formed under a reflective conductive layer as an underlying layer, the probability of electrical corrosion caused by potential differences between the adjacent reflection electrodes and/or between the internal wirings can be decreased.

Electronic Apparatus

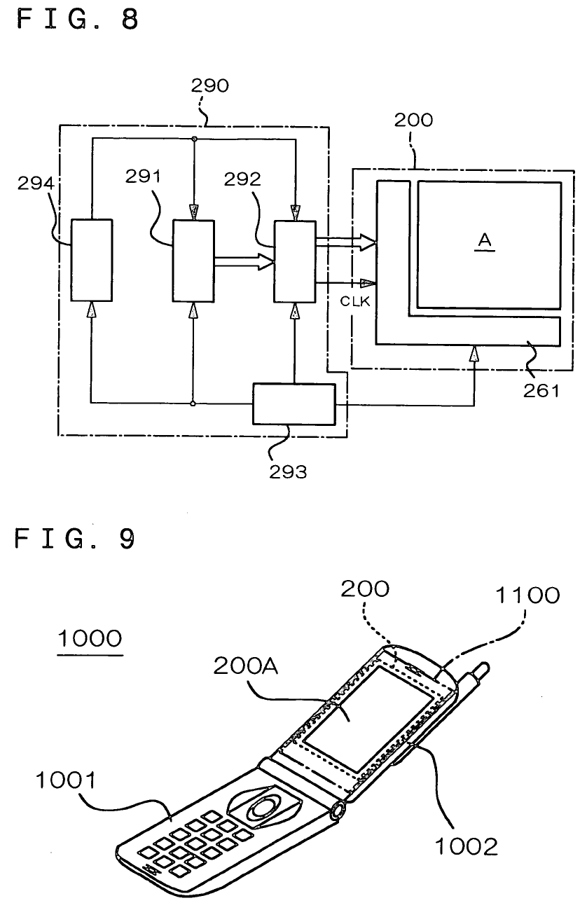

Finally, referring to FIGS. 8 and 9, embodiments of an electronic apparatus according to the present invention will be described above. In this embodiment, the case in which the liquid crystal display device 200, the electro-optic device, is applied to a display unit of an electronic apparatus will be described. FIG. 8 is a schematic diagram showing the entire control system (display control system) for the liquid crystal display device 200 used in the electronic apparatus of this embodiment. The electronic apparatus shown in the figure has a display control circuit 290 including a display information output source 291, a display information processing circuit 292, an electric power circuit 293, and a timing generator 294.

In addition, the liquid crystal display device 200 described above comprises a drive circuit 261 (corresponding to a liquid crystal drive circuit formed of the semiconductor IC chip directly mounted on a liquid crystal panel shown in the figure) for driving operation in the display region A (see FIGS. 1 to 3).

The display information output source 291 has a memory unit including a read only memory (ROM) device, a random access memory (RAM) device, and the like; a storage unit including a magnetic recording disk, an optical recording disk, and the like; and a tuning circuit which tunes and outputs digital image signals, and is formed so that, in response to various clock signals generated by the timing generator 294, display information in the form of image signal or the like in accordance with a predetermined format is supplied to the display information processing circuit 292.

The display information processing circuit 292 has various known circuit including a serial-parallel converter, an amplification/inversion circuit, a rotation circuit, a gamma correction circuit, a clamp circuit, and the like; and after processing input display information, the display information processing circuit 292 supplies the image information to the drive circuit 261 together with clock signal CLK. The drive circuit 261 includes a scanning line drive circuit, a signal line drive circuit, and an inspection circuit. In addition, the electric power circuit 293 supplies predetermined voltages to the above constituent elements.

FIG. 9 shows a cell phone according to one embodiment of an electronic apparatus of the present invention. A cell phone 1000 has an operation unit 1001 and a display unit 1002. On the front surface of the operation unit 1001, a plurality of operational buttons is disposed, and in a mouse piece, a microphone is embedded. In addition, in an earpiece of the display unit 1002, a speaker is embedded.

In the display unit 1002, a circuit board 1100 is provided inside a case body, and on this circuit board 1100, the above liquid crystal display device 200 is mounted. The liquid crystal display device 200 disposed in the case body is formed so that the display surface can be viewed through a display window 200A.

The electro-optic device and the electronic apparatus, according to the present invention, are not limited to the examples shown in the figures, and it is to be understood that various modifications may be made without departing from the spirit and the scope of the present invention. For example, the electro-optic devices in the above embodiments are all liquid crystal display devices each having a liquid crystal panel; however, instead of the liquid crystal panel mentioned above, various electro-optic panels of an inorganic electroluminescent device, an organic electroluminescent device, a plasma display device, and a field emission display (FED) device may also be used. In addition, in the embodiments described above, a liquid crystal panel having a so-called COG (chip on glass) type structure is described in which an IC chip is directly mounted on at least one of the substrates; however, a COF (chip on film) structure may also be used in which a liquid crystal panel is connected to a flexible circuit board or a TAB board, and an IC chip or the like is mounted on this circuit board.

In addition, although the reflective liquid crystal display device is described by way of example in the above embodiments, a transflective liquid crystal display device may also be formed when at least one window portion is provided in the reflective conductive layer in each pixel 200P (see FIG. 2).

Advantages

As described above, according to the present invention, in the electro-optic device having the reflective conductive layers formed of Ag alone or an Ag alloy, a decrease in reflectance of the reflective conductive layer can be suppressed, and in addition, the corrosion resistance thereof can also be improved.

The entire disclosure of Japanese Patent Application No. 2002-311054 filed Oct. 25, 2002 is incorporated by reference.

What is claimed is:

1. An electro-optic device comprising:
a pair of substrates;
an electro-optic material disposed between the substrates; and
means for applying an electric field to the electro-optic material;
a material enclosure region in which the electro-optic material is enclosed;
reflection electrodes provided on one of the pair of substrates in the material enclosure region, the reflection electrodes having a multilayer structure including:
a reflective conductive layer made of one of silver and a silver alloy; and
a transparent conductive layer provided on the reflective conductive layer; and
external wirings connected to the reflection electrodes and provided outside the material enclosure region, the external wirings having a transparent conductive layer equivalent to that of the multilayer structure;
wherein the transparent conductive layer of the reflection electrodes has a thickness larger than that of the reflective conductive layer.

2. The electro-optic device of claim 1, wherein the reflective conductive layer has a thickness of 80 nm to 300 nm.

3. The electro-optic device of claim 1, further comprising an underlying insulating layer between said one of the pair of substrates and said reflective conductive layers.

4. A method for manufacturing an electro-optic device having a pair of substrates, an electro-optic material provided between the substrates, and means for applying an electric field to the electro-optic material, the method comprising:
a step of selectively forming reflective conductive layers made of one of silver and a silver alloy on one of the pair of substrates only in a first region to be used as a material enclosure region in which the electro-optic material is enclosed; and
a step of forming transparent conductive layers in the first region and a second region located outside the material enclosure region, the transparent conductive layers having a thickness larger than that of the reflective conductive layers.

5. The method for manufacturing an electro-optic device of claim 4, wherein the reflective conductive layers are formed to have a thickness of 80 nm to 300 nm.

6. The method for manufacturing an electro-optic device of claim 4, further comprising a step of forming an underlying insulating layer between said one of the pair of substrates and the reflective conductive layers.

7. An electronic apparatus comprising:
the electro-optic device according to claim 1; and
control means for controlling the electro-optic device.
